(19) United States
(12) Patent Application Publication
(10) Pub. No.: US 2025/0378511 A1
(43) Pub. Date: Dec. 11, 2025

(54) Intelligent Adaptive Asset Leasing System with Dynamic User Profiling, Risk Management, and Insurance Frameworks

(71) Applicant: Zohar Dor Lavi, Zurich (CH)

(72) Inventor: Zohar Dor Lavi, Zurich (CH)

(21) Appl. No.: 19/230,103

(22) Filed: Jun. 6, 2025

Related U.S. Application Data
(60) Provisional application No. 63/657,156, filed on Jun. 7, 2024.

(51) Int. Cl. G06Q 50/163

(52) U.S. Cl. CPC G06Q 50/163; G06Q 2220/00

(57) ABSTRACT

The invention relates to a computer-implemented platform for managing the leasing of real estate assets through automated tenant-landlord verification, dynamic risk scoring, and smart contract execution. Tenant and landlord accounts are established via Know Your Customer (KYC) protocols. Tenant creditworthiness scores are computed using financial, employment, and behavioral data, and matched against landlord-defined eligibility thresholds. Lease agreements are executed via blockchain-based smart contracts, ensuring immutable, enforceable records. Rental deposit requirements are dynamically calculated based on tenant risk profiles and lease conditions, and may be fulfilled either through a real-time, event-driven insurance instrument or through financing from an authorized third-party financial institution. The insurance instrument is calibrated algorithmically to reflect changing risk exposure, behavioral history, and contextual data, thereby enabling dynamic collateralization of lease obligations. The platform further comprises modules for structured damage reporting, automated maintenance escalation, dispute resolution workflows, and landlord reputation scoring. All transactional events are logged in a tamper-evident ledger. The system also supports data export and third-party integration with financial institutions, insurers, and regulatory platforms via secure APIs and analytics dashboards.

### TECHNICAL FIELD

The present invention relates generally to the field of real estate technology systems, and more specifically to a computer-implemented platform for managing leasing activities through the integration of artificial intelligence, dynamic insurance provisioning, distributed ledger technologies, and risk-based user profiling mechanisms.

### System Architecture Overview

The system comprises a modular software architecture deployed on a networked computing infrastructure, operable to facilitate end-to-end lifecycle management of digital real estate lease transactions. The system includes verification, scoring, execution, insurance, reporting, and analytics components that collectively ensure secure, compliant, and adaptive lease operations between verified tenants and landlords.

### System Components

### Tenant Profiling Module

Performs KYC-compliant identity verification, including biometric, document-based, and data-driven checks.
Aggregates employment data, income statements, credit bureau data, and behavioral patterns. Computes a dynamic creditworthiness score subject to continuous updates throughout the lease term.

### Landlord Verification Module

Validates ownership documentation, leasing authority, and legal standing.
Integrates with public registries and third-party data providers.
Establishes landlord identity and initial eligibility.

### Eligibility Control Module

Cross-references tenant scores against predefined leasing thresholds set by verified landlords.
Governs access to viewing bookings and lease initiation steps.
Implements dynamic filtering based on matching compatibility profiles.

### Smart Contract Engine

Generates blockchain-based smart contracts encapsulating lease terms, insurance conditions, and payment obligations.
Deploys and executes agreements on a distributed ledger platform.
Maintains immutability, traceability, and automated state transitions.

### Dynamic Collateralization and Insurance Module

Dynamically calculates rental deposit requirements based on tenant-specific credit risk, lease value, and contextual risk factors.
Enables fulfillment of deposit obligations via either a dynamically priced, event-driven insurance instrument or approved third-party financial institution.
The insurance instrument adjusts coverage, exclusions, and premiums in real time according to behavioral signals, incident history, and external market or environmental indicators.
Facilitates risk-managed collateralization without requiring upfront liquidity from the tenant.

### Damage Reporting Subsystem

Enables tenants to submit maintenance requests with timestamps, severity categorization, and multimedia documentation.
Monitors request resolution workflows and escalation triggers.
Feeds response times and outcomes into the landlord scoring engine.

### Landlord Scoring Module

Computes and maintains dynamic landlord reputation scores.
Factors include ticket resolution times, tenant feedback, dispute frequency, and service responsiveness.

### Dispute Resolution Engine

Applies rule-based logic and machine learning to identify contractual breaches.
Manages automated resolution pathways including notifications, Al mediation, and human arbitration workflows.
Logs all proceedings in a blockchain-based evidentiary ledger.

### Audit Logging Layer

Records all lease-related events, smart contract transactions, and score updates in an append-only blockchain ledger.
Ensures tamper-evidence, regulatory compliance, and legal defensibility.

### Verified Profile Export Utility

Generates exportable, tokenized profiles for tenants and landlords.
Provides integration with external platforms such as lending, credit scoring, and mortgage underwriting systems.
Enforces encryption and user consent protocols.

### Risk Analytics Dashboard

Displays real-time portfolio metrics including lease health, behavioral trends, insurance utilization, and scoring movements.
Provides visual intelligence to landlords, insurers, and financial partners.

### Third-Party Integration Module

Facilitates authenticated, structured data exchange with external systems through APIs.
Supports interoperability with banks, insurers, regulatory bodies, and compliance networks.
Ensures real-time availability and synchronization of critical records.

### Industrial Applicability

The invention is applicable to digital real estate leasing platforms operating within regulated markets. It enhances trust, automates operational complexity, and enables risk-aware leasing practices for asset owners, property managers, tenants, insurers, and institutional stakeholders.

1. Adaptive Leasing Platform for Real Estate Assets A computer-implemented platform for adaptive leasing of real estate assets, comprising: a tenant profiling module configured to perform Know Your Customer (KYC) verification and compute a creditworthiness score based on financial, employment, and behavioral data; a landlord verification module configured to validate ownership status, leasing authority, and legal compliance; an eligibility control module configured to evaluate tenant scores against landlord-defined thresholds for leasing approval; a smart contract engine configured to generate lease terms based on inputs from the eligibility control module, bind insurance and collateralization conditions to payment obligations, and deploy executable contracts on a distributed ledger; a dynamic collateralization module configured to calculate rental deposit obligations in real time based on tenant-specific risk factors and lease attributes; wherein such obligations may be satisfied through either (i) an adaptive insurance policy instrument or (ii) a verified third-party financial guarantee; a damage reporting subsystem configured to receive, timestamp, and track tenant-submitted maintenance issues; and a landlord scoring module configured to compute a dynamic reputation score based on response behavior, dispute outcomes, and tenant feedback.

2. Method for Adaptive Tenant-Landlord Matching A computer-implemented method for adaptive tenant-landlord matching, comprising: verifying tenant identity and creditworthiness using financial, employment, and behavioral data; verifying landlord credentials and property ownership; computing compatibility scores based on tenant risk profiles, landlord reputation scores, and historical interaction data; and granting tenants viewing and leasing privileges for properties matching compatibility thresholds.

3. Method for Dynamic Lease Execution and Risk Adjustment A computer-implemented method for executing and managing real estate lease agreements, comprising: generating a tenant risk score based on verified personal, financial, and behavioral data; executing a lease agreement via a blockchain-based smart contract upon eligibility confirmation; dynamically calculating the rental deposit requirement based on tenant-specific risk indicators and lease characteristics; satisfying the deposit requirement via an adaptive insurance policy or approved third-party financial provider; and logging all lease and risk adjustment events in a tamper-evident ledger.

4. Dynamic Insurance Recalibration The platform of claim 1, wherein the adaptive insurance policy dynamically recalibrates coverage terms, exclusions, and premium rates based on updated behavioral signals, incident data, and third-party risk indicators.

5. Smart Contract Ledger Integrity The platform of claim 1, wherein the smart contract engine immutably records lease terms, insurance obligations, and event-based actions in a tamper-evident distributed ledger.

6. Dispute Resolution Engine The platform of claim 1, further comprising a dispute resolution module configured to detect contractual breaches using rule-based and machine learning analytics, and to facilitate resolution workflows including automated mediation, legal notification, and human arbitration.

7. Verified Profile Export Utility The platform of claim 1, wherein verified tenant and landlord profiles are exportable in tokenized or structured data format, subject to user consent and encryption protocols, for use in third-party financial services, including credit assessment, mortgage applications, and rental guarantee underwriting.

8. Maintenance Escalation and Scoring Adjustment The platform of claim 1, wherein the damage reporting subsystem is further configured to automatically escalate unresolved maintenance requests after a predefined resolution window has expired, and wherein such escalations trigger score-adjustment events that decrement the landlord's reputation score computed by the landlord scoring module.

9. Real-Time Tenant Risk Monitoring The platform of claim 1, wherein the tenant profiling module is further configured to continuously update the tenant's creditworthiness score in response to rental behavior, payment compliance, communication logs, and dispute history recorded during the lease term.

10. Blockchain-Based Audit Logging The platform of claim 1, wherein all lease events, score changes, insurance modifications, and dispute outcomes are recorded in an append-only blockchain ledger, accessible for audit, regulatory compliance, and evidentiary review.

11. Risk Analytics Dashboard The platform of claim 1, further comprising a risk analytics interface configured to display aggregated lease performance data, tenant behavior metrics, landlord responsiveness indicators, and insurance activity across managed properties.

12. Third-Party Integration Module The platform of claim 1, further comprising an integration module configured to facilitate authenticated data exchange with external systems, including financial institutions, insurance providers, credit bureaus, and municipal compliance platforms, through standardized application programming interfaces (APIs).
